(19) United States
(12) Patent Application Publication
(10) Pub. No.: US 2024/0185022 A1
(43) Pub. Date: Jun. 6, 2024

(54) QUESTION GENERATION APPARATUS, QUESTION GENERATION METHOD, AND RECORDING MEDIUM

(71) Applicant: NEC Corporation, Tokyo (JP)

(72) Inventors: Kosuke AKIMOTO, Tokyo (JP); Kunihiro Takeoka, Tokyo (JP)

(73) Assignee: NEC Corporation, Tokyo (JP)

(21) Appl. No.: 18/519,286

(22) Filed: Nov. 27, 2023

(30) Foreign Application Priority Data
Dec. 1, 2022 (JP) 2022-193135

(51) Int. Cl. G06N 3/006; G06N 7/01; G06N 20/00

(52) U.S. Cl. CPC G06N 3/006; G06N 7/01; G06N 20/00

(57) ABSTRACT

At least one processor included in a question generation apparatus carries out: a an acquiring process of acquiring a first question to which there are a plurality of answers; a question generating process of generating, for each of the plurality of answers, a second question an answer to which is a character string indicating that answer; an ambiguity verifying process of verifying how many answers there are; and an outputting process of outputting the second question which has fewer answers than the first question, in accordance with a result of verification.

### CROSS REFERENCE TO RELATED APPLICATIONS

This application is based upon and claims the benefit of priority from Japanese Patent Application No. 2022-193135 filed on Dec. 1, 2022, the disclosure of which is incorporated herein in its entirety by reference.

### TECHNICAL FIELD

The present invention relates to a question generation apparatus, a question generation method, and a recording medium.

### BACKGROUND ART

Techniques for reducing the ambiguity of a question have been proposed. The ambiguity of a question indicates that there are a plurality of answers to the question. For example, Patent Literature 1 discloses a technique with which a question generation model is trained so as to output a question upon the input of an incomplete question which lacks a part of the question and a piece of text which contains an answer to the question. When a question to which there are a plurality of answers is inputted, the question generation model outputs a question to which missing information has been added in order for the answers to be narrowed down.

### CITATION LIST

### Patent Literature

### Patent Literature 1

International Publication No. WO 2019/235103

### SUMMARY OF INVENTION

### Technical Problem

However, with the question generation model disclosed in Patent Literature 1, it is impossible to reduce ambiguity by a method other than the method of adding missing information in order to narrow down the answers to an inputted question. For example, besides the addition of information, replacement, deletion, etc. of partial information are possible methods capable of reducing the ambiguity of a question. For example, in a case of an ambiguous question “when work A was released?” as to the work A which has been released both in the form of a movie and in the form of a book, the question generation apparatus disclosed in Patent Literature 1 is incapable of carrying out a process of changing “released” in the question to “published” or “started to be screened”.

As above, with the question generation apparatus disclosed in Patent Literature 1, there is a problem of being incapable, in some cases, of accurately generating a question which has reduced ambiguity.

An example aspect of the present invention has been made in view of the above problem, and an example object thereof is to provide a technique for accurately generating a question having reduced ambiguity.

### Solution to Problem

A question generation apparatus in accordance with an example aspect of the present invention includes at least one processor, and the at least one processor carries out: an acquiring process of acquiring a first question to which there are a plurality of answers; a question generating process of generating, for each of the plurality of answers, a second question an answer to which is a character string indicating that answer; an ambiguity verifying process of verifying, for each of a plurality of second questions each of which is the second question, how many answers there are to that second question; and an outputting process of outputting a second question of the plurality of second questions which has fewer answers than the first question, in accordance with a result of verification carried out in the ambiguity verifying process.

A question generation method in accordance with an example aspect of the present invention includes: at least one processor included in a question generating apparatus acquiring a first question to which there are a plurality of answers; the at least one processor generating, for each of the plurality of answers, a second question an answer to which is a character string indicating that answer; the at least one processor verifying, for each of a plurality of second questions each of which is the second question, how many answers there are to that second question; and the at least one processor outputting a second question of the plurality of second questions which has fewer answers than the first question, in accordance with a result of verification carried out in the verifying.

A recording medium in accordance with an example aspect of the present invention is a computer-readable, non-transitory recording medium having recorded thereon a program for causing a computer to function as a question generation apparatus, and the program causes the computer to carry out: an acquiring process of acquiring a first question to which there are a plurality of answers; a question generating process of generating, for each of the plurality of answers, a second question an answer to which is a character string indicating that answer; an ambiguity verifying process of verifying, for each of a plurality of second questions each of which is the second question, how many answers there are to that second question; and an outputting process of outputting a second question of the plurality of second questions which has fewer answers than the first question, in accordance with a result of verification carried out in the ambiguity verifying process.

### Advantageous Effects of Invention

With an example aspect of the present invention, it is possible to accurately generate a question having reduced ambiguity.

### BRIEF DESCRIPTION OF DRAWINGS

FIG. 1 is a block diagram illustrating a configuration of a question generation apparatus in accordance with a first example embodiment of the present invention.

FIG. 2 is a flowchart illustrating a flow of a question generation method in accordance with the first example embodiment of the present invention.

FIG. 3 is a block diagram illustrating a configuration of a question generation apparatus in accordance with a second example embodiment of the present invention.

FIG. 4 is a diagram illustrating an example process carried out by the question generating section in accordance with the second example embodiment of the present invention.

FIG. 5 is a diagram illustrating an example process carried out by an ambiguity verifying section in accordance with the second example embodiment of the present invention.

FIG. 6 is a diagram illustrating an example process carried out by an outputting section in accordance with the second example embodiment of the present invention.

FIG. 7 is a block diagram illustrating an example hardware configuration of the question generation apparatuses of the example embodiments of the present invention.

### EXAMPLE EMBODIMENTS

### First Example Embodiment

The following description will discuss a first example embodiment of the present invention in detail, with reference to the drawings. The present example embodiment is basic to example embodiments which will be described later.

### Configuration of Question Generation Apparatus 1

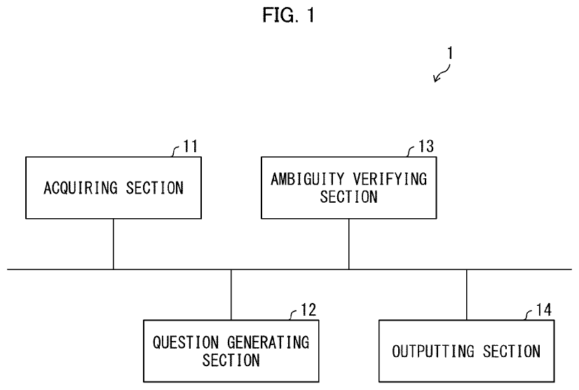

Referring to FIG. 1, a configuration of a question generation apparatus 1 in accordance with the present example embodiment will be described below. FIG. 1 is a block diagram illustrating a configuration of the question generation apparatus 1 in accordance with the present example embodiment.

The question generation apparatus 1 in accordance with the present example embodiment acquires a first question to which there are a plurality of answers and outputs a second question having fewer answers than the first question. In the following description, there being a plurality of answers to a question is also expressed as a question having ambiguity.

The question generation apparatus 1 in accordance with the present example embodiment includes an acquiring section 11, a question generating section 12, an ambiguity verifying section 13, and an outputting section 14, as illustrated in FIG. 1. In the present example embodiment, the acquiring section 11, the question generating section 12, the ambiguity verifying section 13, and the outputting section 14 are components for implementing the acquiring means, the question generating means, the ambiguity verifying means, and the outputting means, respectively.

The acquiring section 11 acquires a first question to which there are a plurality of answers. The acquiring section 11 supplies the question generating section 12 with the first question acquired.

The question generating section 12 generates, for each of the plurality of answers, a second question an answer to which is a character string indicating that answer. The question generating section 12 supplies the ambiguity verifying section 13 with a plurality of second questions generated.

The ambiguity verifying section 13 verifies, for each of the plurality of second questions, how many answers there are to that second question. The ambiguity verifying section 13 supplies the outputting section 14 with a result of the verification.

The outputting section 14 outputs a second question of the plurality of second questions that has fewer answers than the first question, in accordance with the result of the verification carried out by the ambiguity verifying section 13.

As above, a configuration employed in the question generation apparatus 1 in accordance with the present example embodiment is such that an acquiring section 11, a question generating section 12, an ambiguity verifying section 13, and an outputting section 14 are included, the acquiring section 11 being for acquiring a first question to which there are a plurality of second answers, the question generating section 12 being for generating, for each of the plurality of answers, a second question an answer to which is a character string indicating that answer, the ambiguity verifying section 13 being for verifying, for each of the plurality of second questions, how many answers there are to that second question, the outputting section 14 being for outputting a second question of the plurality of second questions that has fewer answers than the first question, in accordance with a result of the verification carried out by the ambiguity verifying section 13.

Thus, the question generation apparatus 1 in accordance with the present example embodiment, which outputs the second question having fewer answers than the first question acquired, provides an example advantage of being capable of accurately generating a question having reduced ambiguity.

### Flow of Question Generation Method S1

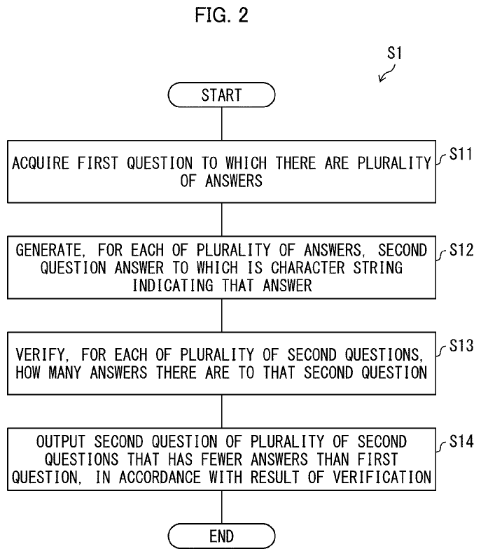

Referring to FIG. 2, a flow of a question generation method S1 in accordance with the present example embodiment will be described below. FIG. 2 is a flowchart illustrating a flow of the question generation method S1 in accordance with the present example embodiment.

### Step S11

In step S11, the acquiring section 11 acquires a first question to which there are a plurality of answers. The acquiring section 11 supplies the question generating section 12 with the first question acquired.

### Step S12

In step S12, the question generating section 12 generates, for each of the plurality of answers, a second question an answer to which is a character string indicating that answer. The question generating section 12 supplies the ambiguity verifying section 13 with a plurality of second questions generated.

### Step S13

In step S13, the ambiguity verifying section 13 verifies, for each of the plurality of second questions, how many answers there are to that second question. The ambiguity verifying section 13 supplies the outputting section 14 with a result of the verification.

### Step S14

In step S14, the outputting section 14 outputs a second question of the plurality of second questions that has fewer answers than the first question, in accordance with the result of the verification carried out by the ambiguity verifying section 13.

As above, a configuration employed in the question generation method S1 in accordance with the present example embodiment is such that steps S11, S12, S13, and S14 are included, the step S11 being the acquiring section 11 acquiring a first question to which there are a plurality of answers, step S12 being the question generating section 12 generating, for each of the plurality of answers, a second question an answer to which is a character string indicating that answer, step S13 being the ambiguity verifying section 13 verifying, for each of the plurality of second questions, how many answers there are to that second question, step S14 being the outputting section 14 outputting a second question of the plurality of second questions that has fewer answers than the first question, in accordance with a result of the verification carried out by the ambiguity verifying section 13. Thus, the question generation method S1 in accordance with the present example embodiment provides the same example advantage that is provided by the question generation apparatus 1 described above.

### Second Example Embodiment

The following description will discuss a second example embodiment of the present invention in detail, with reference to the drawings. A component that has the same function as a component described in the first example embodiment is assigned the same reference sign, and the description thereof is omitted, where appropriate.

### Configuration of Question Generation Apparatus 3

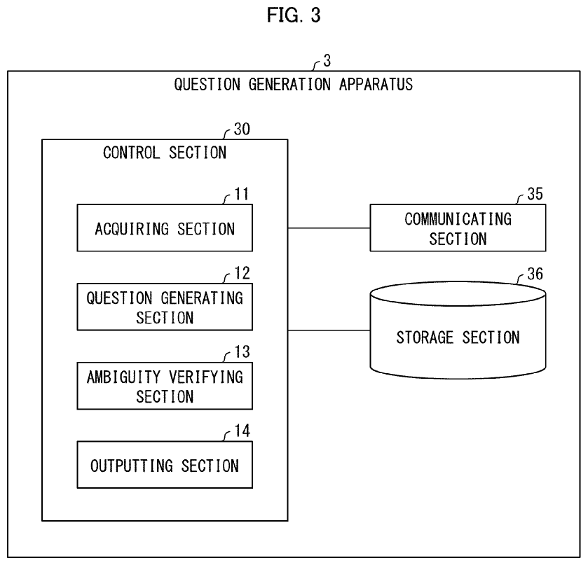

Referring to FIG. 3, a configuration of a question generation apparatus 3 in accordance with the present example embodiment will be described below. FIG. 3 is a block diagram illustrating a configuration of the question generation apparatus 3 in accordance with the present example embodiment.

The question generation apparatus 3 in accordance with the present example embodiment acquires a first question to which there are a plurality of answers and outputs a second question having fewer answers than the first question. In other words, the question generation apparatus 3 outputs a second question having ambiguity which is reduced from that of the first question.

The question generation apparatus 3 in accordance with the present example embodiment includes a control section 30, a communicating section 35, and a storage section 36, as illustrated in FIG. 3.

The communicating section 35 is an interface via which data is transmitted and received. Examples of data received by the communicating section 35 include a first question. Examples of data transmitted by the communicating section 35 include a second question.

Alternatively, the question generation apparatus 3 may have a configuration so as to include a data inputting section and a data outputting section, instead of or in addition to the communicating section 35, the data inputting section being an interface via which the input of data is accepted, the data outputting section being an interface via which data is outputted.

In the storage section 36, data referred to by the control section 30 is stored. Examples of the data stored in the storage section 36 include the first question, a plurality of answers to the first question, the second question, and a result of verification (described later).

### Control Section 30

The control section 30 controls each of the components included in the question generation apparatus 3. The control section 30 includes an acquiring section 11, a question generating section 12, an ambiguity verifying section 13, and an outputting section 14, as illustrated in FIG. 3. In the present example embodiment, the acquiring section 11, the question generating section 12, the ambiguity verifying section 13, and the outputting section 14 are components for implementing the acquiring means, the question generating means, the ambiguity verifying means, and the outputting means, respectively.

The acquiring section 11 acquires data via the communicating section 35. As an example, the acquiring section 11 acquires, via the communicating section 35, a first question to which there are a plurality of answers. The acquiring section 11 may have a configuration so as to acquire, via the communicating section 35, the plurality of answers to the first question. The acquiring section 11 stores, in the storage section 36, the first question acquired.

The question generating section 12 generates a question an answer to which is a character string. As an example, the question generating section 12 generates, for each of the plurality of answers to the first question stored in the storage section 36, a second question an answer to which is a character string indicating that answer. Example processes carried out by the question generating section 12 will be described later.

The ambiguity verifying section 13 verifies how many answers there are to a question. As an example, the ambiguity verifying section 13 verifies, for each of the plurality of second questions stored in the storage section 36, how many answers there are to that second question. The ambiguity verifying section 13 stores, in the storage section 36, a result of the verification indicating how many answers there are. Example processes carried out by the ambiguity verifying section 13 will be described later.

The outputting section 14 outputs data via the communicating section 35. As an example, the outputting section 14 outputs, via the communicating section 35, a second question of the plurality of second questions that has fewer answers than the first question, in accordance with the result of the verification stored in the storage section 36. Example processes carried out by the outputting section 14 will be described later.

### Question Generation Method S2

A question generation method S2 carried out by the question generation apparatus 3 is the same as the question generation method S1 described above, and will be therefore described with reference to FIG. 2 as well.

### Step S11

In step S11, the acquiring section 11 acquires a first question to which there are a plurality of answers. The acquiring section 11 stores, in the storage section 36, the first question acquired.

### Step S12

In step S12, the question generating section 12 acquires the first question stored in the storage section 36, and generates, for each of the plurality of answers to the first question, a second question an answer to which is a character string indicating that answer. The question generating section 12 stores, in the storage section 36, the second question acquired.

In step S12, the question generating section 12 first acquires a plurality of answers to the first question. Examples of a method of the question generating section 12 acquiring the plurality of answers to the first question include a method of acquiring, from a user, the plurality of answers to the first question, via the acquiring section 11.

Examples of the method of the question generating section 12 acquiring the plurality of answers to the first question include a method of using a known question answering model which receives a question as an input and outputs an answer to the question. In this case, the question generating section 12 inputs the first question to the question answering model and acquires a plurality of answers to the first question.

Furthermore, in a case where the question answering model outputs appropriateness which indicates a degree to which an answer is appropriate to a question, the question generating section 12 may treats, as the plurality of answers to the first question, a plurality of answers which have appropriateness equal to or higher than a threshold value, or a predetermined number of answers in decreasing order of the appropriateness.

### Example Process 1 of Question Generating Section 12 Generating Second Question

Next, cited as an example of the method of the question generating section 12 generating the second question is a method of using a question generation model M which receives a single character string as an input and outputs a question an answer to which is the single character string. In this case, the question generating section 12 inputs, to the question generation model M, one of the plurality of answers to the first question. The question generating section 12 then generates, as the second question, the question outputted from the question generation model M.

Examples of the question generation model M include a text-to-text transfer transformer (T5), a bidirectional auto-regressive transformer (BART), and a generative pre-trained transformer (GPT).

### Example Process 2 of Question Generating Section 12 Generating Second Question

As another example of generating the second question, the question generating section 12 may generate the second question by inputting at least one answer of the plurality of answers to the first question and a piece of text associated with the at least one answer, to a question generation model M having been trained so as to receive a single character string and a single piece of text to output a single question an answer to which is the single character string.

The question generating section 12 may acquires, from a user, a piece of text to be inputted to the question generation model M, via the acquiring section 11.

Alternatively, the question generating section 12 may acquire, as the piece of text to be inputted to the question generation model M, a piece of text stored in any server on a network accessible to the question generating section 12. As an example, the question generating section 12 may acquire, as the piece of text to be inputted to the question generation model M, a piece of text which is included in pieces of text stored in any server on the network accessible to the question generating section 12 and which contains a character string that can be an answer. Further, the question generating section 12 may acquire, as the piece of text to be inputted to the question generation model M, a piece of text in which the character string that can be an answer to a question is the subject of a sentence.

Alternatively, the question generating section 12 may acquire, as the piece of text to be inputted to the question generation model M, an article falling into the same category as the answer, from any server on the network accessible the question generating section 12.

Alternatively, in a case where a piece of text that contains an answer has a setting which is configured for the answer and with which another piece of text is accessed, the question generating section 12 may acquire the other piece of text as the piece of text to be inputted to the question generation model M.

As above, the question generating section 12 uses a question generation model M to generate the second question, the question generation model M having been trained so as to receive a single character string and a single piece of text as inputs and output a single question an answer to which is the single character string. Thus, the question generating section 12 is capable of accurately generating the second question an answer to which is a character string indicating an answer to the first question.

### Example Process 3 of Question Generating Section 12 Generating Second Question

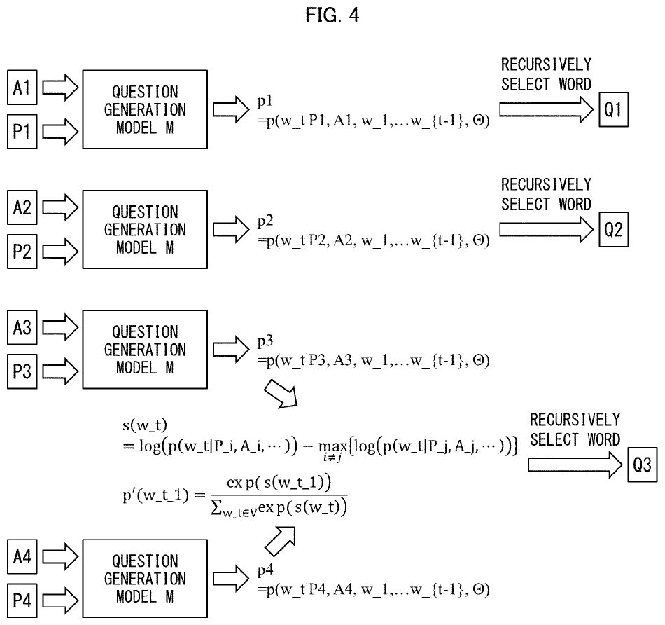

The question generating section 12 may generate the second question with reference to intermediate information which is generated by the question generation model M and which indicates a predictive probability of an ordering of tokens that form a question to be outputted. Referring to FIG. 4, this configuration will be described below. FIG. 4 is a diagram illustrating an example process carried out by the question generating section 12 in accordance with the present example embodiment.

The question generating section 12 inputs an answer A1 and a piece of text P1 associated with the answer A1, to the question generation model M, as illustrated on the upper side of FIG. 4. Outputted from the question generation model M is a probability distribution p1 which is intermediate information calculated with use of Formula (1) below and which predicts the next token, given that the tokens (words) of a question sentence are w_1, w_2, . . . , w_n.

p1=p(w_t|P1,A1,w_1,w_2, . . . ,w_{t−1}, Θ) (1)

In Formula (1), Θ is a parameter of the question generation model M.

The question generating section 12 recursively repeats a process of selecting, with reference to the probability distribution p1 outputted from the question generation model M, a token which has a high probability of occurring as the next token, to generate a second question Q1.

Similarly, the question generating section 12 inputs an answer A2 and a piece of text P2 to the question generation model M, as illustrated in the second instance from the top of FIG. 4. Outputted from the question generation model M is a probability distribution p2 which is calculated with use of Formula (2) below and which predicts the next token.

p2=p(w_t|P2,A2,w_1,w_2, . . . ,w_{t−1}, Θ) (2)

The question generating section 12 recursively repeats a process of selecting, with reference to the probability distribution p2 outputted from the question generation model M, a token which has a high probability of occurring as the next token, to generate the second question Q2.

As above, the question generating section 12 generates the second question with reference to the intermediate information generated by a question generation model M, the question generation model M having been trained so as to receive a single character string and a single piece of text as inputs and output a single question an answer to which is the single character string. Thus, the question generating section 12 is capable of accurately generating the second question an answer to which is a character string indicating an answer to the first question.

### Example Process 4 of Question Generating Section 12 Generating Second Question

Alternatively, the question generating section 12 may generate the second question with reference to first intermediate information and second intermediate information which are generated by a question generation model M, the question generation model M having been trained so as to receive a single character string and a single piece of text as inputs and output a single question an answer to which is the single character string and being configured to generate intermediate information which indicates a predictive probability of an ordering of tokens that form a question to be outputted. The first intermediate information is generated by inputting, to the question generation model M, a first answer of the plurality of answers to the first question and a piece of text associated with the first answer. The second intermediate information is generated by inputting, to the question generation model M, a second answer of the plurality of answers to the first question and a piece of text associated with the second answer, the second answer being different from the first answer. Referring to FIG. 4 again, this configuration will be described below.

The question generating section 12 inputs, to the question generation model M, a first answer A3 and a piece of text P3 associated with the first answer A3, as illustrated on the lower side of FIG. 4. Outputted from the question generation model M is a probability distribution p3 which is first intermediate information calculated with use of Formula (3) below and which predicts the next token, given that the tokens of a question sentence are w_1, w_2, . . . , w_n.

p3=p(w_t|P3,A3,w_1,w_2, . . . ,w_{t−1}, Θ) (3)

Similarly, the question generating section 12 inputs, to the question generation model M, a second answer A4 and a piece of text P4 associated with the second answer A4, the second answer A4 being different from the first answer A3. Outputted from the question generation model M is a probability distribution p4 which is second intermediate information calculated with use of Formula (4) below and which predicts the next token, given that the tokens of a question sentence are w_1, w_2, . . . , w_n.

p4=p(w_t|P4,A4,w_1,w_2, . . . ,w_{t−1}, Θ) (4)

Next, the question generating section 12 generates a second question Q3 having reduced ambiguity, with reference to the first intermediate information and the second intermediate information. As an example, the question generating section 12 generates the second question Q3 by recursively repeating a process of, in a case where attention is focused on the answer A_i, selecting a token w_t such that the probability of the token w_t in a probability distribution p(w_t|P_i,A_i,w_1 . . . )for the answer A_i is high and the probability of the token w_t in a probability distribution p(w_t|P_j,A_j,w_1 . . . ) for an answer A_j different from the answer A_i is low.

Specifically, the question generating section 12 first acquires the probability distribution for the token w_t, p(w_t| P_i,A_i, w_1 . . . ), which predicts the next token for the first answer A_i and the piece of text P_i associated with the answer A_i. For example, in a case of the above-described first answer A3 and piece of text P3 associated with the answer A3, the question generating section 12 acquires the probability distribution p3, which is the first intermediate information.

Next, for each token w_t of a set of tokens which can be outputted by the question generation model M, the question generating section 12 inputs, to the question generation model M, the second answer A_j and a piece of text P_j associated with the second answer A_j, the second answer A_j being different from the first answer A_i. The question generating section 12 then acquires, for each token w_t, a probability of generation of the token w_t, p(w_t|P_j, A_j, w_1 . . . ).

Subsequently, the question generating section 12 uses Formula (5) below to calculate a value s(w_t) which indicates the degree of likelihood with which the token w_t is generated only for the first answer A_i.

$$\\ \begin{matrix}s ( w\_t ) = log ( p ( w\_t \vert P\_i , A\_i , … {}_{} ) ) - {max}_{i \neq j} \{ log ( p ( w\_t \vert P\_j , A\_j , … {}_{} ) ) \} & ( 5 )\end{matrix}$$

The question generating section 12 then uses Formula (6) below to recursively repeat a process of, in a case where attention is placed on the answer A_i, selecting a token which has a high probability of occurring next to the token w_t_1, to create the second question Q3.

$$\\ \begin{matrix}{p}^{{}_{} ′} ( w\_t \_ 1 ) = \frac{exp ( s ( w\_t \_ 1 ) )}{{\sum }_{w \_ t ∈ V} exp ( s ( w\_t ) )} & ( 6 )\end{matrix}$$

In Formula (6), V is a set of tokens which can be outputted by the question generation model M.

As above, the question generating section 12 generates the second question, with reference to the first intermediate information and the second intermediate information, which are generated by the question generation model M, which generates intermediate information indicating a predictive probability of an ordering of tokens that form a question to be outputted. Thus, the question generating section 12 is capable of accurately generating a question an answer to which is a character string and which has reduced ambiguity.

### Step S13

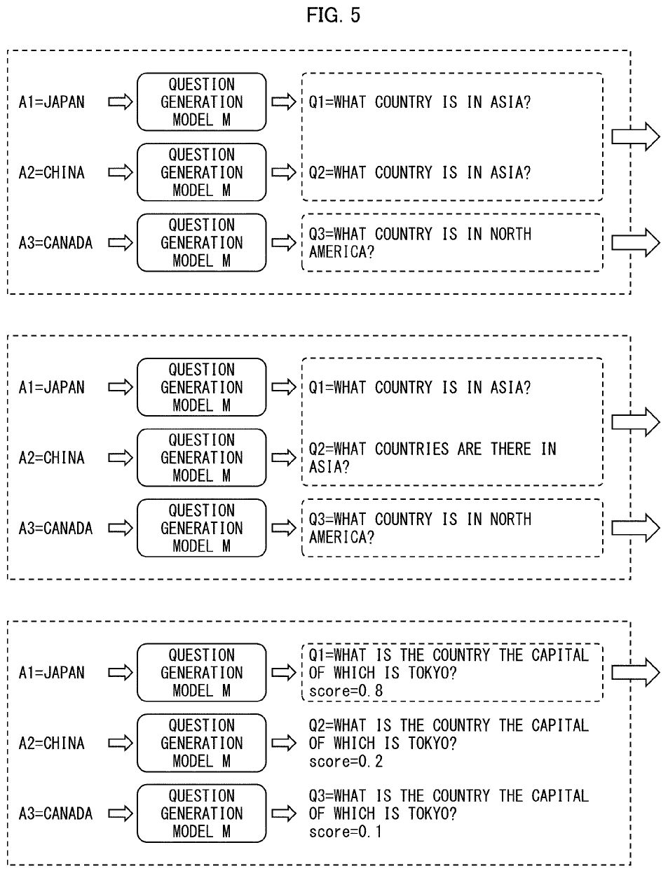

In step S13, the ambiguity verifying section 13 verifies, for each of the plurality of second questions, how many answers there are to that second question. The ambiguity verifying section 13 stores, in the storage section 36, a result of the verification indicating how many answers there are. Referring to FIG. 5, a method of the ambiguity verifying section 13 verifying, for each of the plurality of second questions, how many answers there are to that second question will be described below. FIG. 5 is a diagram illustrating an example process carried out by the ambiguity verifying section 13 in accordance with the present example embodiment.

### Example Process 1 Carried Out by Ambiguity Verifying Section 13

Referring to FIG. 5, an example process carries out by the ambiguity verifying section 13 will be described below. FIG. 5 is a diagram illustrating an example process carried out by the ambiguity verifying section 13 in accordance with the present example embodiment. FIG. 5 is a diagram illustrating an example process carried out by the ambiguity verifying section 13 in a case where the acquiring section 11 acquires the first question “what country is on the earth?” and the question generating section 12 acquires, as the plurality of answers to the first question, the answer A1 “Japan”, the answer A2 “China”, and the answer A3 “Canada”.

For each of the plurality of second questions, the ambiguity verifying section 13 may verify how many answers there are to that second question, in accordance with a similarity which indicates a degree to which that second question and another second question are similar to each other. As an example, for each of the second questions generated by the question generating section 12, the ambiguity verifying section 13 may treat, as the similarity, a degree to which the ordering of tokens that form that second question and the ordering of tokens that form the other second question are similar to each other, to verify how many answers there are to that second question.

For example, in a case where, among the plurality of second questions, there is a second question having the ordering of tokens the same as those of other second questions, the ambiguity verifying section 13 outputs a result of verification indicating the number of answers to the second question, in accordance with the number of the other second questions having the same ordering of tokens.

Assume, as an example, that the answer A1 “Japan” to the first question is inputted to the question generation model M and the question generating section 12 generates the second question Q1 “what country is in Asia?”, as illustrated on the upper side of FIG. 5.

Similarly, assume that the answer A2 “China” to the first question is inputted to the question generation model M and the question generating section 12 generates the second question Q2 “what country is in Asia?”.

Similarly, assume that the answer A3 “Canada” to the first question is inputted to the question generation model M and the question generating section 12 generates the second question Q3 “what country is in North America?”.

In this case, the second question Q1 and the second question Q2 have the same ordering of tokens. Thus, the ambiguity verifying section 13 outputs a result of verification indicating that the number of answers to the second question Q1 “what country is in Asia?” is two which are “Japan” and “China”.

Next, regarding the second question Q3, another second question having the ordering of tokens the same as that of the second question Q3 has not been generated. Thus, the ambiguity verifying section 13 outputs a result of verification indicating that the number of answers to the second question Q3 “what country is in North America?” is one which is “Canada”.

As above, in a case where there are other second questions having the same ordering of tokens that the second question has, the ambiguity verifying section 13 outputs a result of verification indicating the number of answers to the second question, with reference to the number of other second questions having the same ordering of tokens that the second question has. Thus, the ambiguity verifying section 13 is capable of suitably verifying the ambiguity of the second question.

### Example Process 2 Carried out by Ambiguity Verifying Section 13

For each of the plurality of second questions generated by the question generating section 12, the ambiguity verifying section 13 calculates a similarity which indicates a degree to which the ordering of tokens that form that second question and the ordering of tokens that form another second question are similar to each other. In accordance with the number of second questions having the similarity that is equal to or higher than a threshold value, the ambiguity verifying section 13 may then output a result of verification which the number of answers of each of such second questions. Examples of a configuration in which the similarity is calculated include a configuration in which a similarity function sim is used, the similarity function sim being for calculating a cosine similarity between vectors in each of which a question is embedded. Referring to FIG. 5 again, this configuration will be described below.

Assume, as an example, that the answer A1 “Japan” to the first question is inputted to the question generation model M and the question generating section 12 generates the second question Q1 “what country is in Asia?”, as illustrated on the middle part of FIG. 5.

Similarly, assume that the answer A2 “China” to the first question is inputted to the question generation model M and the question generating section 12 generates the second question Q2 “what countries are there in Asia?”.

Similarly, assume that the answer A3 “Canada” to the first question is inputted to the question generation model M and the question generating section 12 generates the second question Q3 “what country is in North America?”.

In this case, since the second question Q1 and the question Q2 include the common words “Asia” and “country (countries)”, the similarity between the question Q1 and the question Q2 becomes equal to or higher than a threshold value. Thus, the ambiguity verifying section 13 outputs a result of verification indicating that the number of answers to the second question Q1 “what country is in Asia?” is two which are “Japan” and “China”.

Further, regarding the second question Q3, another second question similar to the second question Q3 has not been generated. Thus, the ambiguity verifying section 13 outputs a result of verification indicating that the number of answers to the second question Q3 “what country is in North America?” is one which is “Canada”.

As above, with reference to the number of other second questions having a similarity equal to or higher than a threshold value, the similarity indicating a degree to which an ordering of tokens that form a second question and an ordering of tokens that form another second question are similar to each other, the ambiguity verifying section 13 outputs a result of verification indicating the number of answers to the second question. Thus, the ambiguity verifying section 13 is capable of suitably verifying the ambiguity of the second question.

### Example Process 3 Carried out by Ambiguity Verifying Section 13

In generating the second question for each of the plurality of answers, in a case where the question generating section 12 calculates appropriateness which indicates a degree to which the second question is appropriate as a question corresponding to that answer (hereinafter, “score”), the ambiguity verifying section 13 may verify, with reference to the appropriateness, how many answers there are. More specifically, in a case where, for each of the plurality of second questions, the similarity between that second question and another second question is equal to or higher than a threshold value, the ambiguity verifying section 13 verifies how many answers there are to that second question, in accordance with whether the appropriateness of each of that second question and the other second question is equal to or higher than a threshold value. Described below as an example is a case where the threshold value of the score is “0.7”. Referring to FIG. 5 again, this configuration will be described below.

Assume, as an example, that the answer A1 “Japan” to the first question is inputted to the question generation model M, the question generating section 12 generates the second question Q1 “what is the country the capital of which is Tokyo?”, and the question generation model M outputs the score “0.8”, as illustrated on the lower side of FIG. 5.

Similarly, assume that the answer A2 “China” to the first question is inputted to the question generation model M, the question generating section 12 generates the second question Q2 “what is the country the capital of which is Tokyo?”, and the question generation model M outputs the score “0.2”.

Similarly, assume that the answer A3 “Canada” to the first question is inputted to the question generation model M, the question generating section 12 generates the second question Q3 “what is the country the capital of which is Tokyo?”, and the question generation model M outputs the score “0.1”.

In this case, the ambiguity verifying section 13 first judges whether the similarity between the second question Q1 subjected to verification and each of the second questions Q2 and Q3 is equal to or higher than a threshold value. Since the second question Q1 and each of the second questions Q2 and Q3 have the same ordering of tokens, the ambiguity verifying section 13 judges that the similarity between the second question Q1 and each of the second questions Q2 and Q3 is equal to or higher than the threshold value.

Next, the ambiguity verifying section 13 judges whether the score for the second question Q1 subjected to verification is equal to or higher than a threshold value. In a case where the score for the second question Q1 subjected to verification is less than the threshold value, the ambiguity verifying section 13 judges that the second question Q1 is inappropriate to the answer, and does not carry out the subsequent processes. In the example illustrated on the lower side of FIG. 5, the score for the second question Q1 is “0.8”, and the ambiguity verifying section 13 therefore judges that the score for the second question Q1 is equal to or higher than the threshold value.

Subsequently, the ambiguity verifying section 13 calculates the number of second questions which are similar to the second question Q1 subjected to verification and the scores for which are equal to or higher than the threshold value. In the example illustrated on the lower side of FIG. 5, the scores for the second question Q2 and the second question Q3, which are similar to the second question Q1, are “0.2” and “0.1”, respectively, and are each less than the threshold value “0.7”. Thus, the ambiguity verifying section 13 calculates the number of the second questions which are similar to the second question Q1 and the scores for which are each equal to or higher than the threshold value as zero.

The ambiguity verifying section 13 then outputs a result of verification indicating the number of answers to the second question Q1. In the example illustrated on the lower side of FIG. 5, since the number of the second questions which are similar to the second question Q1 and the scores for which are each equal to or higher than the threshold value is zero, the ambiguity verifying section 13 outputs the result of verification indicating that the number of answers to the second question Q1 is one.

As above, in a case where there is a second question that has an ordering of tokens similar to another second question, the ambiguity verifying section 13 judges whether appropriateness which indicates a degree to which each of the other second question and the second question is appropriate as a question corresponding to the answer is equal to or higher than a threshold value. In accordance with the number of the second questions each having appropriateness equal to or higher than a threshold value, the ambiguity verifying section 13 then outputs a result of verification indicating the number of answers to the second question. Thus, in a case where there is a second question that is similar to another second question, when the other second question is inappropriate as a question, the ambiguity verifying section 13 does not judge that the answer to the other second question is an answer to the second question. Thus, the ambiguity verifying section 13 is capable of suitably verifying the ambiguity of the second question.

### Step S14

In step S14, the outputting section 14 outputs a second question of the plurality of second questions that has fewer answers than the first question, in accordance with the result of the verification carried out by the ambiguity verifying section 13. Described below are example processes carried out by the outputting section 14.

### Example Process 1 Carried out by Outputting Section 14

Referring to FIG. 5 again, an example process carried out by the outputting section 14 will be described below.

In the example illustrated in FIG. 5, the plurality of answers to the first question are three answers which are the answer A1 “Japan”, the answer A2 “China”, and the answer A3 “Canada”, as described above. Thus, the outputting section 14 outputs the second question that has been judged, by the ambiguity verifying section 13, to have answers the number of which is less than three.

In the example illustrated on the upper side of FIG. 5, since the number of answers to the second question Q1 is two, the outputting section 14 outputs the second question Q1. Further, since the number of answers to the second question Q3 is one, the outputting section 14 also outputs the second question Q3.

As another example, the example illustrated in the middle part of FIG. 5, the number of answers to the second question Q1 is two. Thus, the outputting section 14 outputs the second question Q1. Further, since the number of answers to the second question Q3 is one, the outputting section 14 also outputs the second question Q3.

As still another example, in the example illustrated on the lower side of FIG. 5, since the number of answers to the second question Q1 is one, the outputting section 14 outputs the second question Q1.

As above, the outputting section 14 outputs the second question that has fewer answers than the first question. Therefore, the outputting section 14 is capable of outputting the second question having reduced ambiguity.

### Example Process 2 Carried Out by Outputting Section 14

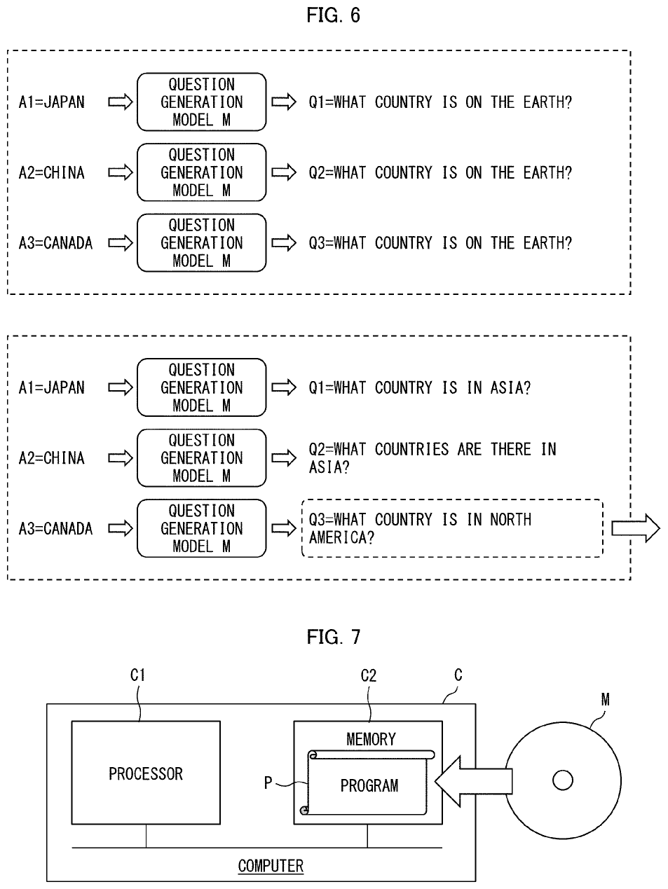

Referring to FIG. 6, another example process carried out by the outputting section 14 will be described. FIG. 6 is a diagram illustrating an example process carried out by the outputting section 14 in accordance with the present example embodiment.

In the example illustrated on the upper side of FIG. 6, the question generating section 12 generates the second question Q1 “what country is on the earth?”, the second question Q2 “what country is on the earth?”, and the second question Q3 “what country is on the earth?”. The second question Q1, the second question Q2, and the second question Q3 have the same ordering of tokens, the ambiguity verifying section 13 outputs a result of verification indicating that the second question Q1 has three answers which are “Japan”, “China”, and “Canada”. The outputting section 14 refers to the result of verification, judges that the number of answers to the second question Q1 is the same as that to the first question, and does not output the second question Q1.

As above, the outputting section 14 does not output the second question that has the answers the number of which is the same as the number of answers to the first question. Thus, the outputting section 14 is capable of outputting only the second question that has reduced ambiguity.

### Example Process 3 Carried out by Outputting Section 14

The outputting section 14 may have a configuration so as to output only the second question that has a single answer. Referring to FIG. 6 again, this configuration will be described below.

In the example illustrated on the lower side of FIG. 6, the question generating section 12 generates the second question Q1 “what country is in Asia?”, the second question Q2 “what countries are there in Asia?”, and the second question Q3 “what country is in North America?”. Since the second question Q1 and the second question Q2 include the common words “Asia” and “country (countries)”, the similarity between the second question Q1 and the second question Q2 is equal to or higher than a threshold value. Thus, the ambiguity verifying section 13 outputs a result of verification indicating that the number of answers to the second question Q1 “what country is in Asia?” is two which are “Japan” and “China”.

Meanwhile, regarding the second question Q3, another second question similar to the second question Q3 has not been generated. Thus, the ambiguity verifying section 13 outputs a result of verification indicating that the number of answers to the second question Q3 “what country is in North America?” is one which is “Canada”.

The outputting section 14 refers to the result of verification, judges that the number of answers to the second question Q1 is not one, and does not output the second question Q1. Meanwhile, the outputting section 14 refers to the result of verification, judges that the number of answers to the second question Q3 is one, and outputs the second question Q3.

With the technique disclosed in Patent Literature 1 described above, a question to which missing information is added in order for the answers to be narrowed down is outputted, as described above. However, even if the missing information is added, the ambiguity is not necessarily eliminated (the number of answers to the question does not necessarily becomes one). For example, even when, with use of the technique disclosed in Patent Literature 1, a question “what country is in the east part of Asia?” for the question “what country is in Asia?” is generated, the ambiguity of the question is not eliminated.

In contrast, the outputting section 14 outputs only the second question that has a single answer. Thus, the outputting section 14 is capable of outputting the second question the ambiguity of which has been eliminated.

### Variation 1

The outputting section 14 may have a configuration so as to, in a case where there are a plurality of second questions to be outputted, preferentially output the second question that has a high similarity with the first question. A method for calculating the similarity is as described above. Alternatively, the outputting section 14 may have a configuration so as to, in a case where there are a plurality of second questions to be outputted, preferentially output the second question that has a low similarity with the first question.

### Variation 2

The ambiguity verifying section 13 may calculate the similarity between pieces of text that have been referred to during the generation of questions carried out by the question generating section 12, and verify the number of answers to each of second questions that have been generated with reference to pieces of text having a high similarity therebetween. For example, in the example illustrated in FIG. 4, in a case where the similarity between the piece of text Pl and the piece of text P2 is high, the ambiguity verifying section 13 may verify the number of answers to each of the second question Q1 and the second question Q2. With this configuration, it is possible to reduce the amount of processes carried out by the ambiguity verifying section 13.

### Software Implementation Example

Some or all of the functions of each of the question generation apparatuses 1 and 3 may be implemented by hardware such as an integrated circuit (IC chip), or may be implemented by software.

In the latter case, each of the question generation apparatuses 1 and 3 is provided by, for example, a computer that executes instructions of a program that is software implementing the foregoing functions. An example (hereinafter, computer C) of such a computer is illustrated in FIG. 7. The computer C includes at least one processor C1 and at least one memory C2. The memory C2 has recorded thereon a program P for causing the computer C to operate as the question generation apparatuses 1 and 3.

The processor C1 of the computer C retrieves the program P from the memory C2 and executes the program P, so that the functions of the question generation apparatuses 1 and 3 are implemented.

Examples of the processor C1 can include a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, and a combination thereof. Examples of the memory C2 can include a flash memory, a hard disk drive (HDD), a solid state drive (SSD), and a combination thereof.

The computer C may further include a random access memory (RAM) into which the program P is loaded at the time of execution and in which various kinds of data are temporarily stored. The computer C may further include a communication interface via which data is transmitted to and received from another apparatus. The computer C may further include an input-output interface via which input-output equipment such as a keyboard, a mouse, a display or a printer is connected.

The program P can be recorded on a non-transitory, tangible recording medium M capable of being read by the computer C. Examples of such a recording medium M can include a tape, a disk, a card, a semiconductor memory, and a programmable logic circuit. The computer C can obtain the program P via such a recording medium M. Alternatively, the program P can be transmitted via a transmission medium. Examples of such a transmission medium can include a communication network and a broadcast wave. The computer C can obtain the program P also via such a transmission medium.

### Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

The whole or part of the example embodiments disclosed above can be described as, but not limited to, the following supplementary notes.

### Supplementary Note 1

A question generation apparatus including: an acquiring means for acquiring a first question to which there are a plurality of answers; a question generating means for generating, for each of the plurality of answers, a second question an answer to which is a character string indicating that answer; an ambiguity verifying means for verifying, for each of a plurality of second questions each of which is the second question, how many answers there are to that second question; and an outputting means for outputting a second question of the plurality of second questions which has fewer answers than the first question, in accordance with a result of verification carried out by the ambiguity verifying means.

### Supplementary Note 2

The question generation apparatus described in supplementary note 1, in which the ambiguity verifying means verifies, for each of the plurality of second questions, how many answers there are to that second question, in accordance with a similarity which indicates a degree to which that second question and another second question of the plurality of second questions are similar to each other.

### Supplementary Note 3

The question generation apparatus described in supplementary note 1 or 2, in which the question generating means generates the second question by inputting, to a question generation model, at least one answer of the plurality of answers to the first question and a piece of text associated with the at least one answer, the question generation model having been trained so as to receive a single character string and a single piece of text as inputs and output a single question an answer to which is the single character string.

### Supplementary Note 4

The question generation apparatus described in supplementary note 1 or 2, in which: the question generating means generates the second question, with reference to first intermediate information and second intermediate information which are generated by a question generation model, the question generation model having being trained so as to receive a single character string and a single piece of text as inputs and output a single question an answer to which is the single character string and being configured to generate intermediate information which indicates a predictive probability of an ordering of tokens that form a question to be outputted; the first intermediate information is generated by inputting, to the question generation model, a first answer of the plurality of answers to the first question and a piece of text associated with the first answer; and the second intermediate information is generated by inputting, to the question generation model, a second answer of the plurality of answers to the first question generation model and a piece of text associated with the second answer, the second answer being different from the first answer.

### Supplementary Note 5

The question generation apparatus described in supplementary note 2, in which for each of the plurality of second questions, the ambiguity verifying means treats, as the similarity, a degree to which an ordering of tokens that form that second question and an ordering of tokens that form another second question of the plurality of second questions, to verify how many answers there are to that second question.

### Supplementary Note 6

The question generation apparatus described in supplementary note 2, in which: in generating the second question for each of the plurality of answers, the question generating means calculates appropriateness which indicates a degree to which the second question is appropriate as a question corresponding to that answer; and for each of the plurality of second questions, in a case where that the similarity between that second question and another second question of the plurality of second questions is equal to or higher than a threshold value, the ambiguity verifying means verifies how many answers there are to that second question, in accordance with whether the appropriateness of each of that second question and the other second question is equal to or higher than a threshold value.

### Supplementary Note 7

A question generation method including: a question generation apparatus acquiring a first question to which there are a plurality of answers; the question generation apparatus generating, for each of the plurality of answers, a second question an answer to which is a character string indicating that answer; the question generation apparatus verifying, for each of a plurality of second questions each of which is the second question, how many answers there are to that second question; and the question generation apparatus outputting a second question of the plurality of second questions which has fewer answers than the first question, in accordance with a result of verification carried out in the verifying.

### Supplementary Note 7a

The question generation method described in supplementary note 7, in which in the verifying, for each of the plurality of second questions, how many answers there are to that second question is verified in accordance with a similarity which indicates a degree to which that second question and another second question of the plurality of second questions are similar to each other.

### Supplementary Note 8

A program for causing a computer to function as a question generation apparatus, the program causing the computer to function as: an acquiring means for acquiring a first question to which there are a plurality of answers; a question generating means for generating, for each of the plurality of answers, a second question an answer to which is a character string indicating that answer; an ambiguity verifying means for verifying, for each of a plurality of second questions each of which is the second question, how many answers there are to that second question; and an outputting means for outputting a second question of the plurality of second questions which has fewer answers than the first question, in accordance with a result of verification carried out by the ambiguity verifying means.

### Supplementary Note 8a

The program described in supplementary note 8, in which the ambiguity verifying means verifies, for each of the plurality of second questions, how many answers there are to that second question, in accordance with a similarity which indicates a degree to which that second question and another second question of the plurality of second questions are similar to each other.

### Supplementary Note 9

A question generation apparatus including at least one processor, the at least one processor carrying out: an acquiring process of acquiring a first question to which there are a plurality of answers; a question generating process of generating, for each of the plurality of answers, a second question an answer to which is a character string indicating that answer; an ambiguity verifying process of verifying, for each of a plurality of second questions each of which is the second question, how many answers there are to that second question; and an outputting process of outputting a second question of the plurality of second questions which has fewer answers than the first question, in accordance with a result of verification carried out in the ambiguity verifying process.

It should be noted that this question generation apparatus may further include a memory, and this memory may have stored therein a program for causing the at least one processor to carry out the acquiring process, the question generating process, the ambiguity verifying process, and the outputting process. In addition, a computer-readable, non-transitory, and tangible recording medium may have this program recorded thereon.

### REFERENCE SIGNS LIST

1, 3: Question generation apparatus
11: Acquiring section
12: Question generating section
13: Ambiguity verifying section
14: Outputting section

1. A question generation apparatus comprising at least one processor, the at least one processor carrying out:
an acquiring process of acquiring a first question to which there are a plurality of answers;
a question generating process of generating, for each of the plurality of answers, a second question an answer to which is a character string indicating that answer;
an ambiguity verifying process of verifying, for each of a plurality of second questions each of which is the second question, how many answers there are to that second question; and
an outputting process of outputting a second question of the plurality of second questions which has fewer answers than the first question, in accordance with a result of verification carried out in the ambiguity verifying process.

2. The question generation apparatus according to claim 1, wherein
in the ambiguity verifying process, for each of the plurality of second questions, the at least one processor verifies how many answers there are to that second question, in accordance with a similarity which indicates a degree to which that second question and another second question of the plurality of second questions are similar to each other.

3. The question generation apparatus according to claim 1, wherein
in the question generating process, the at least one processor generates the second question by inputting, to a question generation model, at least one answer of the plurality of answers to the first question and a piece of text associated with the at least one answer, the question generation model having been trained so as to receive a single character string and a single piece of text as inputs and output a single question an answer to which is the single character string.

4. The question generation apparatus according to claim 1, wherein:
in the question generating process, the at least one processor generates the second question, with reference to first intermediate information and second intermediate information which are generated by a question generation model, the question generation model having being trained so as to receive a single character string and a single piece of text as inputs and output a single question an answer to which is the single character string and being configured to generate intermediate information which indicates a predictive probability of an ordering of tokens that form a question to be outputted;
the first intermediate information is generated by inputting, to the question generation model, a first answer of the plurality of answers to the first question and a piece of text associated with the first answer; and
the second intermediate information is generated by inputting, to the question generation model, a second answer of the plurality of answers to the first question generation model and a piece of text associated with the second answer, the second answer being different from the first answer.

5. The question generation apparatus according to claim 2, wherein
in the ambiguity verifying process, for each of the plurality of second questions, the at least one processor treats, as the similarity, a degree to which an ordering of tokens that form that second question and an ordering of tokens that form another second question of the plurality of second questions, to verify how many answers there are to that second question.

6. The question generation apparatus according to claim 2, wherein:
in the question generating process, in generating the second question for each of the plurality of answers, the at least one processor calculates appropriateness which indicates a degree to which the second question is appropriate as a question corresponding to that answer; and
in the ambiguity verifying process, for each of the plurality of second questions, in a case where that the similarity between that second question and another second question of the plurality of second questions is equal to or higher than a threshold value, the at least one processor verifies how many answers there are to that second question, in accordance with whether the appropriateness of each of that second question and the other second question is equal to or higher than a threshold value.

7. A question generation method comprising:
at least one processor included in a question generating apparatus acquiring a first question to which there are a plurality of answers;
the at least one processor generating, for each of the plurality of answers, a second question an answer to which is a character string indicating that answer;
the at least one processor verifying, for each of a plurality of second questions each of which is the second question, how many answers there are to that second question; and
the at least one processor outputting a second question of the plurality of second questions which has fewer answers than the first question, in accordance with a result of verification carried out in the verifying.

8. A computer-readable, non-transitory recording medium having recorded thereon a program for causing a computer to function as a question generation apparatus, the program causing the computer to carry out:
an acquiring process of acquiring a first question to which there are a plurality of answers;
a question generating process of generating, for each of the plurality of answers, a second question an answer to which is a character string indicating that answer;
an ambiguity verifying process of verifying, for each of a plurality of second questions each of which is the second question, how many answers there are to that second question; and
an outputting process of outputting a second question of the plurality of second questions which has fewer answers than the first question, in accordance with a result of verification carried out in the ambiguity verifying process.
